(19) United States
(12) Patent Application Publication
(10) Pub. No.: US 2012/0006860 A1
(43) Pub. Date: Jan. 12, 2012

(54) SELF-CLOSING VALVE WITH VALVE CAP

(75) Inventors: Udo Suffa, Ebersdorf Bel Coburg (DE); Eberhard Köbke, Marktrodach (DE); Hermann Goetz, Neustadt bei Coburg (DE)

(73) Assignee: KUNSTSTOFFTECHNIK WAIDHOFEN AN DER THAYA GMBH, Thaya (AT)

(21) Appl. No.: 12/300,330

(22) PCT Filed: May 1, 2007
(86) PCT No.: PCT/EP07/54236

§ 371 Date: Jul. 28, 2011

(30) Foreign Application Priority Data
May 8, 2006 (DE) 10 2006 021 564.8

(51) Int. Cl. B67D 7/06

(52) U.S. Cl. 222/491

(57) ABSTRACT

The invention relates to a self-locking valve for releasing a product capable of flowing out of a volume. The valve comprises a valve cap with an outlet; a guide disk which is located on the product side of the valve cap and is at a distance to the valve cap; a valve membrane which is supported between the valve cap and the guide disk and has a guide opening; a cavity between the valve cap and the valve membrane; at least one passage opening which extends from the volume of the product to the cavity; a duct for sucking air back which is formed by means of the outlet, the guide opening, as well as by the opened air gap resulting from lifting the valve membrane off the guide disk.

### BACKGROUND

The present invention concerns a self-closing valve with a valve cap for the dispensing of a free-flowing product.

A typical application for self-closing valves are containers in which the dispensing of a free-flowing contents occurs by squeezing the container. One example of this are so-called squeeze bottles for skin care products. Thanks to the reduction of the inner volume of the bottle when it is squeezed by the user, the pressure inside it increases, so that the contents, such as a liquid soap, are dispensed through the valve. Thanks to the self-closing action of the valve, the contents are prevented from escaping unintentionally without this pressure increase, even when the container is not closed with a cap and even when the product bears by its gravity against the dispensing zone of the valve.

A self-closing valve for the dispensing of a liquid or pastelike product is known from DE 102 18 363 A1. The valve includes a valve membrane, which is shaped convex in the direction of the product. The valve membrane is formed with a support ring at the margin, shaped by extrusion. For a proper dispensing of the product, the valve membrane is underpinned by a plate part. The plate part, in turn, is supported by spring arms, which causes increased construction expense for the valve. Another drawback of this solution is that the plate part in particular obstructs the air equalization, so that the container has to exert a large restoring force.

A self-closing valve with a closure membrane for dispensing a fluid filling in a compressible container is known from DE 196 13 130 A1. In the nonactivated installed condition, the closure membrane has a lower support edge and an upper closure cover extending concavely basically in the dispensing direction. In a normal dispensing process, opening slits in the closure membrane open up reliably and almost abruptly at a certain pressure. When the dispensing is completed, the container is restored, so that the closure membrane is pulled back into the concave starting condition. The opening slits are now broken through toward the inside, so that air is sucked back in. In order to improve this suction, grooves can be introduced between the closure membrane and its support. The drawbacks of this solution are the limited tightness and the large partial vacuum needed for the back suctioning. In order to achieve a large back suction effect, the containers have to be configured with corresponding spring action. This necessitates a high input of material for the container, so that the manufacturing costs are increased.

A self-closing valve with a plate-shaped valve membrane is known from EP 0 388 828 A1. The valve membrane has a central dispensing opening, which is placed on a support plate and thereby sealed off. This solution has no possibility of back suctioning of air.

A self-closing closure for a container or a tube is known from DE 43 29 808 C2, in which an outlet opening in a closure cover is closed by a closure pin. When the pressure increases, the closure pin is forced inward, so that the outlet opening is released and the product can escape through the outlet opening. The drawback to this solution is that a large pressure is needed for the closure pin to release the outlet opening. Furthermore, this solution has no possibility of back suctioning of air, so it would only be suitable for limited products. Because of the relatively high cost of fabrication, this solution is little suited to the production of consumer goods.

A self-closing valve with an inwardly cambered valve membrane is known from DE 195 80 254 B4. The valve membrane, in turn, has a central dispensing opening, which is placed on a support plate and thereby sealed off. The valve membrane is supported at the top by a support flange, against which the valve membrane thrusts from the bottom in a radially outward bearing zone. A pin can be configured on the support plate, which travels into the dispensing opening in the closed position and thus enables a reliable seal. The lateral bearing region of the valve membrane can be configured so that it is deformed inwardly when the pressure is low, thereby freeing up an air pathway for the back suction. However, such a deformation requires a large partial vacuum, so that the wall of the container has to exert correspondingly large restoring forces.

Thus, the problem of the present invention is to provide a self-closing valve for the dispensing of a free-flowing product, which is very simple and economical to produce and requires only a slight low pressure for the back suction of air. Furthermore, a good sealing effect of the valve is desired, in order to reliably prevent unintentional escaping of even slight amounts of the free-flowing product.

### SUMMARY OF THE INVENTION

This problem is solved by a self-closing valve according to the enclosed claim 1. In the self-closing valve, a valve membrane for the dispensing of the product switches from a closing position to a dispensing position. In the closing position, an outlet opening of a valve cap is closed by the valve membrane. In the dispensing position, the valve membrane is lifted from the valve cap, so that the product can emerge. In a back suction position, air from the outside enters through the outlet opening and a guide opening of the valve membrane between the valve membrane and a guide disk, so that it gets into the reservoir volume.

A special benefit of this invention consists in that a very simplified construction and a distinctly improved back suction of air can be achieved at the same time. The valve membrane can be formed by a simple plastic disk, which can be produced very economically. A container with a valve according to the invention need not have very great restoring forces. Consequently, the wall of the container can be thin, so that the use of the invented valve enables a material-sparing and low-cost production of the container.

Further benefits, details, and modifications of the invention will appear from the following descriptions of several embodiments, making reference to the drawings. These show:

### BRIEF DESCRIPTION OF THE DRAWINGS

FIG. 1: a cross sectional representation of a first embodiment of a self-closing valve per the invention in a closing position;

FIG. 2: a cross sectional representation of the valve shown in FIG. 1 in a dispensing position;

FIG. 3: a cross sectional representation of the valve shown in FIG. 1 in a back suction position;

FIG. 4: a cross sectional representation of a second embodiment of a self-closing valve per the invention in a closing position;

FIG. 5: a cross sectional representation of the valve shown in FIG. 4 in a dispensing position;

FIG. 6: a cross sectional representation of the valve shown in FIG. 4 in a back suction position;

FIG. 7: a cross sectional representation of a third embodiment of a self-closing valve per the invention in a closing position;

FIG. 8: a cross sectional representation of the valve shown in FIG. 7 in a dispensing position;

FIG. 9: a cross sectional representation of the valve shown in FIG. 7 in a back suction position;

FIG. 10: a cross sectional representation of a fourth embodiment of a self-closing valve per the invention in a closing position;

FIG. 11: a cross sectional representation of the valve shown in FIG. 10 in a dispensing position;

FIG. 12: a cross sectional representation of the valve shown in FIG. 10 in a back suction position.

### DETAILED DESCRIPTION

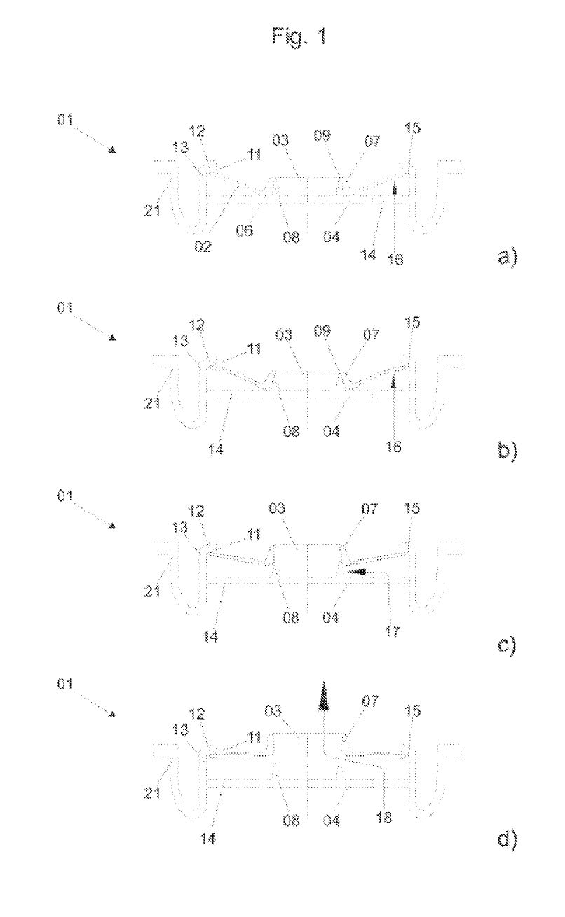

FIG. 1 shows a cross sectional representation of a first embodiment of an invented self-closing valve 01 in a closed position. It should be noted in general for an understanding of the figures that the valve is configured for installation on a container (not shown), for example, by being inserted into the neck of a squeeze bottle.

The valve 01 includes a round circular valve membrane 02 with a round circular guide opening 03 in its center. The valve membrane 02 basically has the shape of a disk spring and also exhibits comparable spring properties. In FIG. 1, the valve membrane 02 is shown in a position when the valve 01 is closed. In this closed position, the valve membrane 02 lies with the periphery of its guide opening 03 pressed against a valve cap 04. A round bearing surface 06 formed in this way seals off the valve membrane 02 from the valve cap 04. On the side of the valve membrane 02 opposite the bearing surface 06, the guide opening 03 has an encircling support collar 07. The support collar 07 lies with play against four guide pins 08, by which the valve membrane 02 is guided laterally. The four guide pins 08 are arranged on a guide disk 09. The outer circumference of the valve membrane 02 is formed by an encircling edge 13. The encircling edge 11 in the closed position shown lies on an inclined, encircling impact surface 12 of the guide disk 09. The guide disk 09 and the valve cap 04 are firmly connected to a round fastening frame 13 of the valve 01.

The shape of the valve membrane 02 in the closed position is cambered in the exit direction and, except for the support collar 07, has the shape of a truncated cone envelope surface. The valve membrane 02 is elastically deformable, and the truncated cone shape and the support collar 07 impose a pretensioning, which determines the deformability. A lateral movement of the valve membrane 02 is prevented by the four guide pins 08. The valve membrane 02 is held on the one hand by being supported in the bearing surface 06 on the valve cap 04 and on the other hand by the bearing of the encircling edge 11 against the guide disk 09. Consequently, the valve membrane 02 is held clamped between the valve cap 04 and the guide disk 09. No additional fastening means is required to install the valve membrane 02. In the embodiment shown, the guide pins 08 and the guide disk 09 including its slanted impact surface 12 pass one into the other as a single piece, so that a simple manufacture is possible. But these components can also be designed as several pieces. In the design shown, a lateral shifting of the valve membrane 02 is prevented with four guide pins 08. Of course, a different number of guide pins 08 can also be chosen, or the guide pins 08 can be arranged on the valve cap 04. A lateral shifting of the valve membrane can also we prevented with other guide means. For example, a disk with openings can be arranged in the guide opening 03.

By configuring the support collar 07 on the valve membrane 02, the valve membrane 02 is reinforced in the region of the bearing surface 06. This ensures that the bearing surface 06 forming in the closed position tightly seals off a cavity 16, which remains between the valve cap 04 and the valve membrane 02.

The guide disk 09 has passage openings 14 in its peripheral region, through which the product or air can go from the container to the cavity 16 between the valve membrane 02 and the valve cap 04. The product flowing in direction 17 from the volume of the container or also the air present there cannot emerge in the depicted closing position, since no product and no air can get in between the valve membrane 02 and the valve cap 04 in the region of the bearing surface 06. Since the valve membrane 02 is elastically pressed against the valve cap 04, small pressure increases inside the container do not yet let the product or the air between the valve membrane 02 and the valve cap 04 exit through the cavity 16. For example, one must firmly grasp the squeeze bottle with a closure cap when opening and closing it. This will slightly increase the internal pressure in the bottle, yet no escape of product is intended, and this is assured by the valve 01 of the invention.

The air present outside of the container can get in through a channel which is formed by an outlet opening 18 in the valve cap 04, through the guide opening 03 of the valve membrane 02, through the guide pins 08 which are spaced apart, and through the region between the valve membrane 02 and the guide disk 09. However, the air flowing in direction 19 cannot get into the container, since the valve membrane 02 rests by its encircling edge 11 against the guide disk 09. As there is no substantial pressure difference between the inside and the outside of the container, the air cannot get in between the valve membrane 02 and the guide disk 09 into the cavity 16.

The self-closing valve 01 is especially suitable for so-called squeeze bottles in which a manual squeezing of the bottle dispenses the free-flowing product. For this, the valve 01 is arranged in the opening of the bottle provided for the dispensing. The embodiment of the invented valve shown in FIG. 1 is inserted for this purpose by its round fastening frame 13 into the opening of the bottle. But the invented valve can also be designed as an integral part of the container.

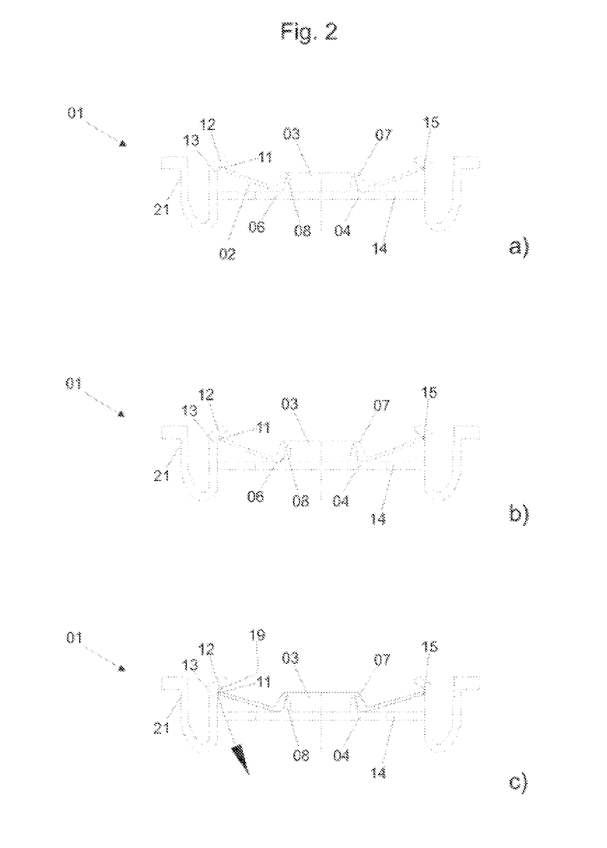

FIG. 2 shows a cross sectional representation of the valve 01 shown in FIG. 1 in a dispensing position. FIG. 2 shows the same parts as FIG. 1, and uses the same reference numbers. The dispensing position serves to deliver the product from the container. For a squeeze bottle, the dispensing position is achieved by squeezing the bottle. For this, the squeeze bottle is usually held so that the opening with the valve points downward. The valve 01 then assumes the dispensing position when the pressure inside the container becomes so great that the pressure acting in the cavity 16 on the valve membrane 02 has produced a deformation of the valve membrane 02 in the direction of the guide disk 09. The truncated cone shape of the valve membrane 02 is slightly flattened by this deformation. Now, the valve membrane 02 no longer lies against the valve cap 04, so that a passage gap 21 has formed. The product located in the cavity 16 or also the air located there can now get to the outside through the passage gap 21 and through the outlet opening 18. A directional arrow 22 indicates the direction of flow of the product. Since the passage gap 21 has formed about the guide opening 03, the passage gap 21 has a sufficiently large cross section for the product to flow through. The size of the guide opening 03 in this embodiment dictates the size of the passage gap 21 and thus, along with the size of the outlet opening 18, the amount and flow rate of the product.

For the switch from the closed position to the dispensing position, the force by which the valve membrane 02 is pressed against the valve cap 04 must be overcome. Therefore, in order to deliver the product, the force on a squeeze bottle must be increased until the valve 01 switches to the dispensing position. This has the result that the squeeze bottle will abruptly relax during this process once the excess pressure imposed by the squeezing has dissipated. At this instant, a certain amount of product will be delivered. The valve 01 and the squeeze bottle can be dimensioned so that the suddenly delivered amount of product corresponds to the typical amount of product used. Thus, the user can intuitively deliver the typical amount of product consumed. If a larger amount is desired, the bottle should be squeezed further after the valve 01 switches to the dispensing position. Since the force for switching to the dispensing position has already been overcome, it requires less effort to deliver larger amounts of product. The user can feel the exceeding of the maximum force for the switch to the dispensing position and also hear it through the emergence of the product or air. This improves the consumer qualities, especially the tactile handling of the squeeze bottle outfitted with the invented valve.

If the force imposed on the bottle drops below a particular threshold, the valve membrane 02 will again lie against the valve cap 04, so that the valve 01 falls back into the closed position. Due to the circular concentric design of the valve membrane 02 and the stress imposed on the valve membrane 02, the dropping back into the closed position is once again abrupt. There is a definite closing moment, resulting in a clean cut off of the stream of liquid being pressed out, so that further dripping is largely prevented.

When the valve 01 has switched to the closed position after delivering the product, the increased internal pressure is dissipated by the delivery of the product. At this instant, the valve membrane 02 has again taken up its initial shape and position. This occurs, for example, when the user has relaxed the force of squeezing of the bottle, so that no more product is delivered; however, the force is still large enough for the deformation of the bottle to remain. In this state, the volume of the bottle is smaller than the volume of the undeformed bottle. If the force deforming the bottle is entirely relaxed, the elastic restoring forces of the wall will act. Since the volume of the bottle has decreased during this time, a partial vacuum is created in the bottle, so that the valve 01 switches to a back suction position.

FIG. 3 shows a cross sectional representation of the valve 01 shown in FIG. 2 in the back suction position. FIG. 3 shows the same parts as FIG. 1, using the same reference numbers. In the back suction position shown, the low pressure in the bottle has had the effect that the outside high pressure of the air in the region between the valve membrane 02 and the guide disk 09 has deformed the valve membrane 02. Because of this deformation, the valve membrane 02 has lifted off from the guide disk 09 in the region of the encircling edge 11, so that an encircling air gap 23 has formed. The truncated conical shape of the valve membrane 02 is in turn slightly flattened as compared to the closing position. Since the peripheral marginal region of the valve membrane 02 is not supported in the region of the encircling edge 11 and not reinforced by a stiffening or similar configuration, it only takes a very small force to form the encircling air gap 23. Consequently, with the valve 01 of the invention, a back suction of air is possible already when a very slight partial vacuum is present. The air can get into the container from the outside through the channel which is formed by the outlet opening 18, through the guide opening 03, through the spaced-apart guide pins 08, through the region between the valve membrane 02 and the guide disk 09 and through the encircling air gap 23, and finally through the cavity 16 and through the passage openings 14. This air flow is indicated by an arrow 24. Since the air gap 23 is formed all around, the air gap 23 has a sufficiently large cross section for the back suction of air. The air can flow practically unhindered from the outside to the inside and dissipate the partial vacuum prevailing there. As soon as the partial vacuum has been fully dissipated, the squeeze bottle is once again in its initial shape. Through the encircling gap 23 a sufficient back suction of air is also assured when segments of the gap 23 are still closed by remaining portions of the product being delivered. But even these portions of product are sucked back into the bottle by the back suction effect. This also holds for portions of product that are remaining in the region of the outlet opening 18 or in the region of the guide pins 08, since a back suction effect also occurs there.

The valve cap 04 has a tube extension 26 running about the outlet opening 18. This tube extension 26 is advantageous for the product to be delivered to the desired place, so that no product portions remain on the valve cap 04 in the region of the outlet opening 18. If any product portions should remain on the tube extension 26 at the end of the dispensing process, these can be wiped off by hand, for example. Furthermore, the tube extension 26 protects the inside of the valve 01.

The invented valve in the embodiment presented more closely consists of only three parts. This enables a simple and fast assembly, since only the valve membrane 02 and the guide disk 09 need to be forced into the fastening frame 13 with a stamp. The guide disk 09 is secured by a snap-in connection in the valve cap 04 or in the fastening frame 13. The valve membrane 02 can preferably consist of silicone or a comparable soft elastic plastic, while the fastening frame 13 can be made as an injection molded part from a more stiff plastic.

The fastening frame 13 including the valve cap 04 can also be configured in a modified embodiment as a single piece with the squeeze bottle or a similar container.

In one modified embodiment, the lateral guiding of the valve membrane 02 occurs by guide elements, which lie with play against the encircling edge 11 of the valve membrane 02. In this embodiment, one can do away with guide means that project into the guide opening 03.

Advisedly, when not in use the valve is further covered by a closure cap (not shown), which is placed in familiar manner on the squeeze bottle. The closure cap is advantageously provided with a pin, which enters into the tube extension 26 and closes it.

FIGS. 4 to 6 show cross sectional representations of a second embodiment of the invented self-closing valve 01. FIG. 4 shows the valve 01 in a closed position. FIG. 5 shows the valve 01 in a dispensing position and FIG. 6 shows the valve 01 in a back suction position. The reference numbers used in FIGS. 4 to 6 match those used in FIGS. 1 to 3 when they characterize the same features. The embodiment shown in FIGS. 4 to 6 differs from the embodiment shown in FIGS. 1 to 3 only in that it has a grooved guide pin 27 in place of the four guide pins. The grooved guide pin 27 is configured as a single piece with the guide disk 09. The grooved guide pin 27 is hollow on the inside, thus saving on material. The envelope surface of the guide pin 27 has several grooves 28, extending from the region of the outlet opening 18 to the guide disk 09. The grooved guide pin 27 has the same functions as the four guide pins shown in FIGS. 1 to 3. First, the grooved guide pin 27 prevents a sideways movement of the valve membrane 02. Secondly, the grooves 28 of the guide pin 27 form part of the channel for back suction of air, since air from the outside can get through the outlet opening 18 through the grooves 28 into the region between the guide disk 09 and the valve membrane 02.

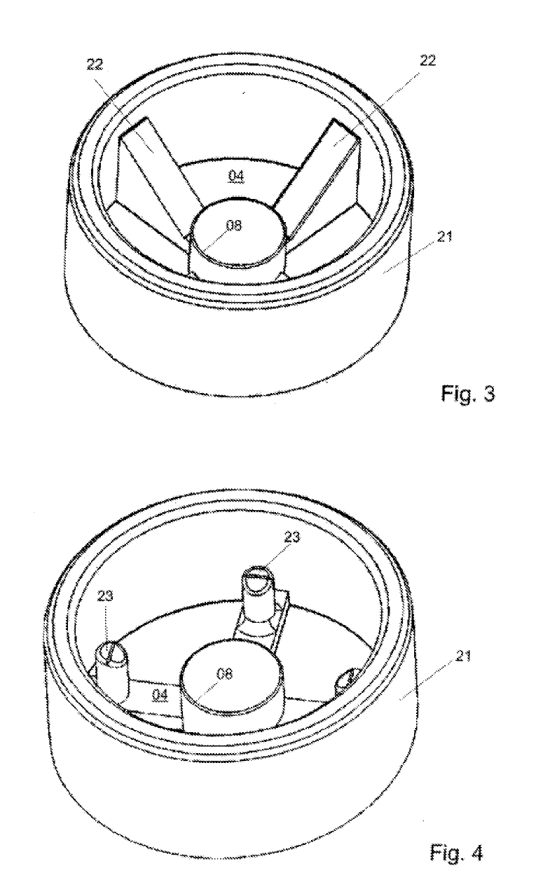

FIGS. 7 to 9 show cross sectional representations of a third embodiment of the invented self-closing valve 01. FIG. 7 shows the valve 01 in a closed position. FIG. 8 shows the valve 01 in a dispensing position and FIG. 9 shows the valve 01 in a back suction position. The reference numbers used in FIGS. 7 to 9 match those used in FIGS. 1 to 6 when they characterize the same features.

The embodiment shown in FIGS. 7 to 9 differs from the embodiment shown in FIGS. 4 to 6 in that the valve membrane 02 has a concentrically arranged sealing lip 29, which stands opposite a conically shaped inner surface of a bushing 31 of the outlet opening 18 of the valve cap 04. Since the sealing lip 29 of the valve membrane 02 projects into the conical bushing 31 with clamping action and thus the sealing lip 29 is pressed against the inner surface of the bushing 31, a secure sealing of the cavity 16 in the bearing surface 06 is assured, especially in the closed position. Instead of a support collar, the valve membrane 02 has a washer 32, at whose center the guide opening 03 is arranged. The grooved guide pin 27, once again, engages in the guide opening 03 and thus assures a guiding of the valve membrane 02. Since the guide opening 03 due to its arrangement in the washer 32 is smaller than that of the embodiment shown in FIGS. 4 to 6, the grooved guide pin 27 also has a smaller diameter. At the transition to the guide disk 09, the grooved guide pin 27 has a pedestal 33, which on the one hand stabilizes the grooved guide pin 27 and on the other hand forms a stop for the guiding of the valve membrane 02. The guiding of the valve membrane 02 in the guide opening 03 of the washer 32 allows for an unhindered guidance in the axis of the grooved guide pin 27 as far as the pedestal 33.

An axial play 34 is present between the valve cap 04 and the guide disk 09. Thanks to this axial play 34, the valve membrane 02 can be further compressed in the closed position, so that a larger closing force can be achieved both between the encircling edge 11 of the valve membrane 02 and the guide disk 09, and also in the bearing surface 06. This compressing of the valve membrane 02 can be achieved by a strong impact of the bottle against the valve 01, so that the product acts by its weight and the resulting momentum against the product side of the guide disk 09. The compressing of the valve membrane 02 can also be accomplished by a vigorous shaking or similar process. When the pressure in the container and consequently that in the cavity 16 increases to reach the dispensing position, the valve membrane 02 again forces the guide disk 09 and the valve cap 04 apart in the range of the axial play 34. Consequently, the sealing lip 29 of the valve membrane 02 can lift off from the bearing surface 06 in the bushing 31 of the valve cap 04, so that the product can flow out in the direction 22.

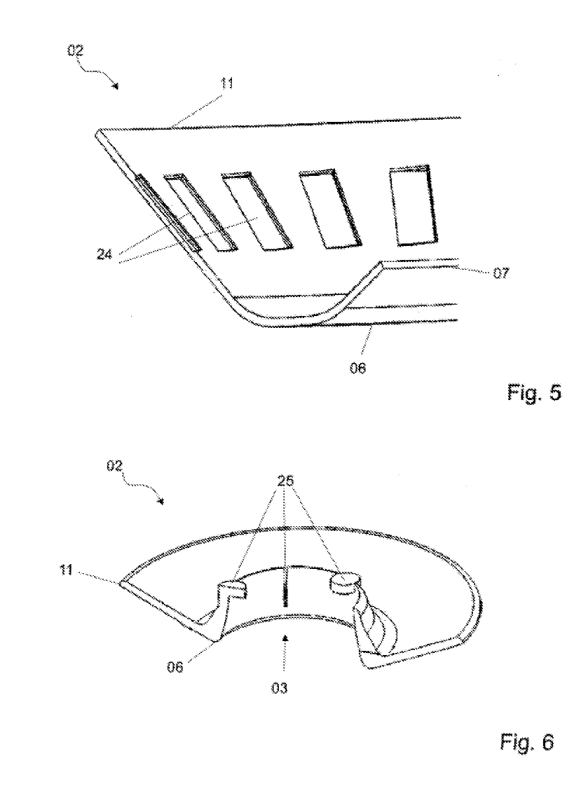

FIGS. 10 to 12 show cross sectional representations of a fourth embodiment of the invented self-closing valve 01. FIG. 10 shows the valve 01 in a closed position. FIG. 11 shows the valve 01 in a dispensing position and FIG. 12 shows the valve 01 in a back suction position. The reference numbers used in FIGS. 10 to 12 match those used in FIGS. 7 to 9 when they characterize the same features.

The embodiment shown in FIGS. 10 to 12 differs from the embodiment shown in FIGS. 7 to 9 only as regards a special configuration of the valve membrane 02. The valve membrane 02 has an encircling camber 36 in the direction of the valve cap 04 in the region between the sealing lip 29 and the encircling edge 11. The camber 36 has the effect that the pressure of the product present in the cavity 16 upon switching to the dispensing position produces a deformation of the valve membrane 02 in the region between the sealing lip 29 and the camber 36. This deformation allows the valve membrane 02 to lift off far from the bearing surface 06 of the bushing 31 of the valve cap 04, without requiring any major force to accomplish this. FIG. 11 shows the valve 01 in the dispensing position, wherein the valve membrane 02 is deformed far in the direction of the guide disk 09 in the region between the sealing lip 29 and the camber 36. This embodiment of the invented valve 01 ensures an especially easy and secure dispensing of the product. The camber 36, furthermore, accomplishes an easier lifting off of the encircling edge 11 of the valve membrane 02 from the guide disk 09, since the valve membrane 02 can also be easily deformed in the region between the encircling edge 11 and the camber 36. Consequently, in this embodiment of the invented valve 01, a back suction of air is assured already by a very small partial vacuum inside the container.

1. Self-closing valve for dispensing a free-flowing product from a volume, comprising:
a valve cap with an outlet opening;
a guide disk, which is arranged on the product side of the valve cap and at a distance from it;
a valve membrane, which is supported between the valve cap and the guide disk and has a guide opening, while the valve membrane can change between a closing position, a dispensing position and a back suction position based on pressure differences created;
a cavity between the valve cap and the valve membrane, which in the closed position and in the back suction position is sealed off against the outlet opening by the valve membrane on the valve cap bearing against the outlet opening and in the dispensing position it is opened by the lifting off of the valve membrane of the valve cap from the outlet opening;
at least one passage opening, which extends from the product volume to the cavity;
a channel for back sucking of air, which in the back suction position is formed at least by the outlet opening, the guide opening and an air gap which opens up when the valve membrane is lifted off from the guide disk, this channel for back sucking of air being closed in the closing position and in the dispensing position by the valve membrane bearing against the guide disk.

2. The self-closing valve of claim 1, wherein the valve membrane is guided by a guide element, wherein the guide element projects into the guide opening of the valve membrane and at the same time forms part of the channel for the back suction of air.

3. The self-closing valve of claim 1, wherein the outlet opening, the valve membrane and the guide opening are circular and concentric in configuration.

4. The self-closing valve of claim 1, wherein the valve membrane has the shape of a disk spring, which is cambered in the discharge direction in the closed position.

5. The self-closing valve of claim 2, wherein the guide opening of the valve membrane has a support collar, and the valve membrane is guided by the support collar on the guide element.

6. The self-closing valve of claim 2, wherein the valve membrane has a concentric washer, and the guide opening is arranged in the washer.

7. The self-closing valve of claim 1, wherein the valve membrane has an encircling sealing lip, and the sealing lip in the closed position is pressed against a conically shaped inner surface of a bushing of the outlet opening of the valve cap.

8. The self-closing valve of claim 1, wherein the guide disk is arranged with an axial play relative to the valve cap.

9. The self-closing valve of claim 2, wherein the guide element is formed by several guide pins spaced apart from each other and fastened to the guide disk.

10. The self-closing valve of claim 2, wherein the guide element is formed by a grooved guide pin, which has at least one groove on its envelope surface, forming at the same time part of the channel for back suction of air.

11. The self-closing valve of claim 1, wherein the valve membrane has an encircling concentric camber in the direction of the valve cap.

12. The self-closing valve of claim 1, wherein the valve membrane is made from a silicone plastic or a thermoplastic elastomer.

13. The self-closing valve of claim 1, wherein the valve cap is made as a single piece with a fastening frame, which can be fastened in the bottle neck opening of a squeeze bottle.

14. The self-closing valve of claim 13, wherein the valve cap and the fastening frame are made as a single piece with the squeeze bottle.

15. The self-closing valve of claim 1, wherein the guide disk is secured by a snap-in connection in the valve cap and/or in the fastening frame.

16. The self-closing valve of claim 1, wherein the valve membrane rests by its outer circumference against an encircling impact surface of the guide disk, inclined in the direction of the valve membrane, in the closed position.

17. The self-closing valve of claim 1, wherein the valve cap has a tube extension on its outer side.

18. The self-closing valve of claim 1, wherein the passage opening is arranged repeatedly in the periphery of the guide disk.
